(19) United States
(12) Patent Application Publication
(10) Pub. No.: US 2025/0320760 A1
(43) Pub. Date: Oct. 16, 2025

(54) Automatic Door Opener and Motor Vehicle Having an Automatic Door Opener

(71) Applicant: Bayerische Motoren Werke Aktiengesellschaft, Muenchen (DE)

(72) Inventors: Erik BRADEN, Muenchen (DE); Markus KOEDDERITZSCH, Woerthsee (DE)

(21) Appl. No.: 18/866,652

(22) PCT Filed: Jun. 21, 2023
(86) PCT No.: PCT/EP2023/066850

§ 371 Date: Nov. 18, 2024

(30) Foreign Application Priority Data
Jul. 12, 2022 (DE) 10 2022 117 394.1

(51) Int. Cl. E05F 15/616; E05F 1/10

(52) U.S. Cl. CPC E05F 15/616; E05F 1/105; E05Y 2201/22; E05Y 2800/252; E05Y 2900/531

(57) ABSTRACT

An automatic door opener, more particularly for use in a motor vehicle, has a housing, a plunger mounted to be longitudinally movable in the housing, and an electric plunger drive that is designed to move the plunger forward and back between a resting position, in which it is withdrawn into the housing, and an actuation position, in which it protrudes out of the housing. In addition to the electric plunger drive, a mechanical auxiliary drive, is provided that is designed, in the event of actuation, to be able to move the plunger from the resting position to the actuation position.

### BACKGROUND AND SUMMARY

The invention relates to an automatic door opener and, more particularly, to an automatic door opener for use in a motor vehicle. It further relates to a motor vehicle having a vehicle body and at least one vehicle door with an electrically operable door lock and also at least one such automatic door opener.

The increasing demands on motor vehicle aerodynamics have led to external door handles currently being installed in a countersunk manner in many motor vehicles and moved out of the door by a motor only when required. However, even these door handles installed in a countersunk manner still cause some air resistance, which one would like to avoid.

There are motor vehicles under development in which the doors no longer have even external door handles. Instead, only a small operating point is provided for example in or under the door skin, via which, however, no or no sufficiently high pulling force can be applied to the door in order to open the same from outside. Via this operating point, an electric door opening mechanism is usually activated, which forces the door slightly out of the door portion of the vehicle body with the door lock unlocked, so that the door can be gripped at the door edge and pulled open. This is known on the market, for example in body covers for the trunk or in tailgates of station wagons which are not used for passengers to get in and out.

Such opening mechanisms for body flaps or vehicle doors have an automatic door opener, a so-called door presenter, which is arranged in the vehicle door and which opens the vehicle door by a small gap by a plunger pressing against a restraining bar of the door lock or against the side frame at the end of the door cut-out of the vehicle body. The plunger is driven by a small and compact electric motor and is merely designed to apply a comparatively low force which is sufficient to force the door slightly out of the door cut-out of the vehicle body in the normal state. If the door is iced up in winter, for example, or if the vehicle has no power as a result of an accident, then this electric plunger drive no longer functions in the desired manner. Such a known door presenter can consequently neither generate high forces, nor is it ready for use when the vehicle has lost power; it is able to operate only when there is a functioning electrical system on the motor vehicle.

The object of the present invention is to provide an improved automatic door opener which functions reliably even when there is a high required opening force and after a vehicle collision. Furthermore, it is the object to provide a motor vehicle having such an automatic door opener with which at least one vehicle door can be opened reliably even under difficult conditions and even after an accident.

The objects are achieved by an automatic door opener and by a motor vehicle having such an automatic door opener in accordance with the features of the independent claim(s).

An automatic door opener, more particularly for use in a motor vehicle, is provided with a housing, a plunger mounted to be longitudinally movable in the housing, and an electric plunger drive that is designed to move the plunger forward and back between a resting position, in which it is withdrawn into the housing, and an actuation position, in which it protrudes out of the housing. According to the invention, this automatic door opener is distinguished by the fact that in addition to the electric plunger drive, a separate, preferably mechanical, auxiliary drive is provided that is designed to be able to move the plunger from the resting position to the actuation position in the event of activation.

In normal operation, the electric plunger drive, which forms an electric-motor or electromagnetic actuator for actuating the plunger, ensures that during an opening operation, the plunger is moved from its resting position which is assumed when the vehicle door is completely closed, to its actuation position and applies a relative force between the vehicle door and the vehicle body, in order to open the vehicle door by the plunger stroke and thus to move it into what is known as a gripping position, in which the vehicle door can be gripped from outside by a hand and opened completely. However, if in the event of an overload the force of the electric plunger drive is no longer sufficient to force the door into the gripping position, for example because the door or the door seal has iced up in winter, the auxiliary drive having a force or pressure store and separate from the electric plunger drive can be triggered and, in an assistance operation, assist the electric plunger drive with an opening force additionally applied by the auxiliary drive.

The auxiliary drive needs no electrical energy for the movement of the plunger, instead it has a preferably mechanical energy store for the purpose. Instead of a mechanical energy store, a pneumatic or hydraulic pressure reservoir can be provided as an energy store which, when the auxiliary drive is triggered, for example actuates a piston-cylinder unit by means of the pressurized fluid stored in it, which applies an axial force to the plunger and effects the axial movement of the plunger. Alternatively, the energy store can have a pyrotechnic actuator device which—as, for example, in an airbag—by igniting a chemical produces an expanding pressurized fluid, which then likewise, for example, actuates a piston-cylinder unit.

If, in the event of a power failure, the electric plunger drive no longer functions at all, for an emergency operation of the automatic door opener, the auxiliary drive provided according to the invention can be activated, which then moves the plunger from the resting position into the actuation position with its stored energy.

Further preferred and advantageous design features of the automatic door opener according to the invention are the subject matter of the dependent claims.

It is particularly advantageous if the electric plunger drive has an electric or electromagnetic drive device. In normal operation, this electric or electromagnetic drive device, for example an electric motor or an electromagnet, generates the force which is needed to move the plunger from its resting position to the actuating position and also back from the actuating position to the resting position. Preferably, the electric or electromagnetic drive device also drives a mechanical gearing provided between the electric or electromagnetic drive device and the plunger.

It is also of particular advantage if the auxiliary drive has a spring or is formed by a spring, which acts between the housing and the plunger and which, in a standby position, assumes a state pretensioned in the direction of the actuation position of the plunger and is kept in this pretensioned state by a restraining device. This spring forms a mechanical energy store which, independent of an electric energy supply, can apply the necessary force to move the plunger. It is advantageous if the spring is a compression spring. The restraining device can be triggerable mechanically or electrically to release the spring.

It is particularly advantageous if the restraining device is triggerable electrically to release the spring. In this way, the mechanical complexity of the structure is reduced and, in particular, the triggering device for the restraining device is simplified in design terms, which triggering device for the electrical actuation of the restraining device, for example, can be formed by an electric pushbutton or switch which is provided in the door skin or in the skin of the vehicle body and which, when the restraining device of the automatic door opener is actuated, triggers an associated vehicle door or preferably centrally the restraining devices of the automatic door openers of all the vehicle doors.

In a preferred development of the automatic door opener according to the invention, the plunger drive is designed to move the plunger from the actuation position to the resting position counter to the force of the spring when the auxiliary drive is triggered, and to secure the spring in the pretensioned state by means of the restraining device. In this way, after the spring of the auxiliary drive has been triggered, this spring is able to be tensioned again by the plunger drive, and the auxiliary drive can be moved back again from the position triggered in emergency operation to its standby position.

Particularly preferable is a development of the invention in which a locking device is provided, which is designed to lock the plunger moved into the actuation position by the triggered auxiliary drive in emergency operation in the actuation position. This locking ensures that even with a high expenditure of force, it is no longer possible for the vehicle door opened in emergency operation to be completely closed again; it can at most fall back into the gripping position.

A motor vehicle having a vehicle body and at least one vehicle door with an electrically operable door lock and at least one automatic door opener according to the invention is characterized in that the at least one automatic door opener is provided to exert a force between a vehicle door and a doorframe on the body side or another component fixed to the body. The automatic door opener can be attached either to the door or to the vehicle body or to the other component fixed to the body. In the sense of the present invention, a vehicle door is to be understood as any covering of a body opening that is to be opened, in particular a classic pivoting door, a sliding door or else another body flap (for example a tailgate or front flap). The automatic door opener according to the invention is suitable for all these types of covering of body openings that are to be opened. An automatic door opener can be provided for each vehicle door or flap or else a plurality of automatic door openers can be assigned to a vehicle door or flap.

Preferably, an electric control device is provided, which is designed to supply the electrically operable door lock and the plunger drive with electrical energy when an electric contactor is actuated, and the control device is designed to unlock the electrically operable door lock in the event of an overload of the plunger drive or after receiving a crash signal representing a vehicle accident when the electrical contactor is actuated, and to trigger the restraining device electrically or electromechanically and as a result to activate the auxiliary drive. If, for example, the door is iced up in winter during high atmospheric humidity and great cold, so that the force of the plunger drive is no longer sufficient and the latter is overloaded, the auxiliary drive is additionally activated in order to move the door to the gripping position. If, on the other hand, a crash signal is triggered in the event of an accident, then the control device changes to emergency operation, in which the electrical contactor, for example an electric pushbutton or switch provided in the door skin or the body skin, no longer activates the electric plunger drive when actuated, but instead triggers the restraining device and as a result activates the auxiliary drive, which then moves the vehicle door into the gripping position by using mechanical energy.

In a preferred embodiment of the motor vehicle configured according to the invention, an emergency power supply is provided which, in the event of an accident-based disconnection of the motor vehicle electrical system or a failure of the motor vehicle system, supplies at least the electric control device, the electrically operable door lock and the restraining device with electrical energy. Such an emergency power supply can be formed, for example, by power stores which are locally provided and preferably assigned to the corresponding vehicle door and which, for a predefined time period, have sufficient electrical energy stored in order to unlock the electric door lock and to trigger the associated restraining device.

The principle of the invention is coupling an electric door presenter having an additional auxiliary drive that is separate from the electric plunger drive, therefore redundant with respect thereto, to a mechanical energy store, for example to a spring or to an energy store designed as a pressure reservoir or a pyrotechnic energy store. The spring-tensioned mechanical door presenter tensions the spring with about 1000 N and keeps the spring permanently tensioned.

In the event of a crash, the energy store, for example the spring, is released via an electrical pulse when opening the door. As a result, considerably less electrical energy must be kept in reserve, which saves overall space, weight and costs, since the electrical system only releases the energy stored in the energy store and does not first have to generate it. This further has the advantage that in the event of a crash, the door presenter remains extended and renewed closing of the door is prevented. Furthermore, the electric door presenter can operate with considerably lower forces in regular operation, and the electric plunger drive does not have to be designed with a higher force (for example 1000 N) for regular operation.

This solution is also suitable for an iced-up door. Here, the electric plunger drive can then retard the development of the mechanical force of the auxiliary drive somewhat, so that excessively abrupt opening does not occur.

The solution described is also possible for unpowered vehicle access if, for example, the vehicle battery is empty. The solution can be implemented directly in the lock or else as a separate component.

Preferred exemplary embodiments of the invention with additional design details and further advantages are described and explained in more detail below with reference to the appended drawings.

### BRIEF DESCRIPTION OF THE DRAWINGS

FIG. 1 is a schematic partially sectioned view of an automatic door opener provided in a motor vehicle in the resting position;

FIG. 2 shows the automatic door opener from FIG. 1 in the actuation position in normal operation; and

FIG. 3 shows the automatic door opener from FIG. 1 in the actuation position in emergency operation.

### DETAILED DESCRIPTION OF THE DRAWINGS

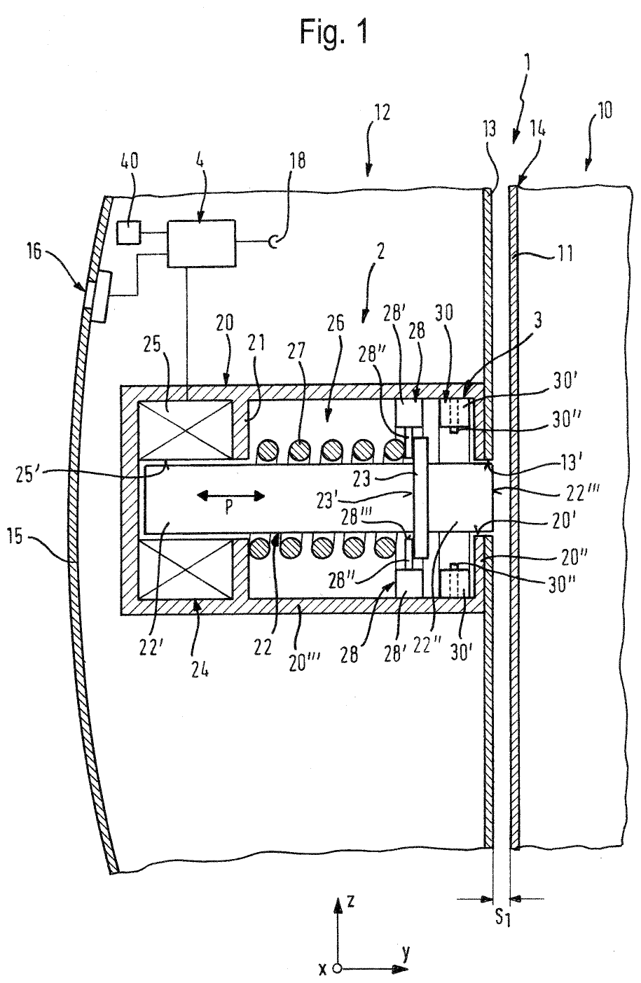

FIG. 1 shows a vertical cross section through part of a vehicle door 12 of a motor vehicle 1 and a corresponding part of a doorframe 14, which is formed by a vehicle body 10 of the motor vehicle 1 around a door opening. The vehicle door 12 is in its closed position here, in which the door inner wall 13 is opposite and close to a doorframe wall 11, so that a narrow air gap S₁ is formed between these two. Door seals that are usually provided are not illustrated here for clarity. The vehicle door 12 is delimited on its outer side by a door outer skin 15.

An automatic door opener 2 is arranged in the interior of the vehicle door 12 as a constituent part of a door opening mechanism. The automatic door opener 2 has a housing 20, which is firmly connected to the structure of the vehicle door 12, for example fastened to the door inner wall 13 by a housing front wall 20′ facing the door inner wall 13.

In the interior of the housing 20, a plunger 22 that is movable in its longitudinal direction (here along the vehicle transverse direction y) is provided. The backward and forward mobility of the plunger 22 is symbolized by the double arrow P in FIG. 1. The plunger 22 is driven by a plunger drive 24 which is provided in the housing 20 and which, in the example shown, is formed by an electromagnetic drive device 25, which is of annular design and into the central opening 25′ of which the plunger 22 plunges with a first end 22′ directed toward the door outer skin 15 as an armature. Of course, instead of an electromagnetic drive, another electric drive, for example having an electric-motor driven worm screw, can be provided for the axial movement of the plunger 22. With its second end 22″ facing the doorframe wall 11, the plunger 22 penetrates a housing opening 20′ in the housing front wall 20″ and an opening 13′ in the door inner wall 13 that is concentric therewith. In the example shown, the inner end face 22″ of the plunger 22 pointing toward the doorframe wall 11 ends flush with the inner wall 13 when in the resting position of the automatic door opener 2 and is located opposite the doorframe wall 11.

In the region of its second end 22″, at a distance from the inner end face 22″, the plunger 22 is provided with a circumferential collar 23, the radius of which is greater than the radius of the plunger 22, so that the circumferential collar 23 projects radially outward beyond the circumferential wall of the plunger 22.

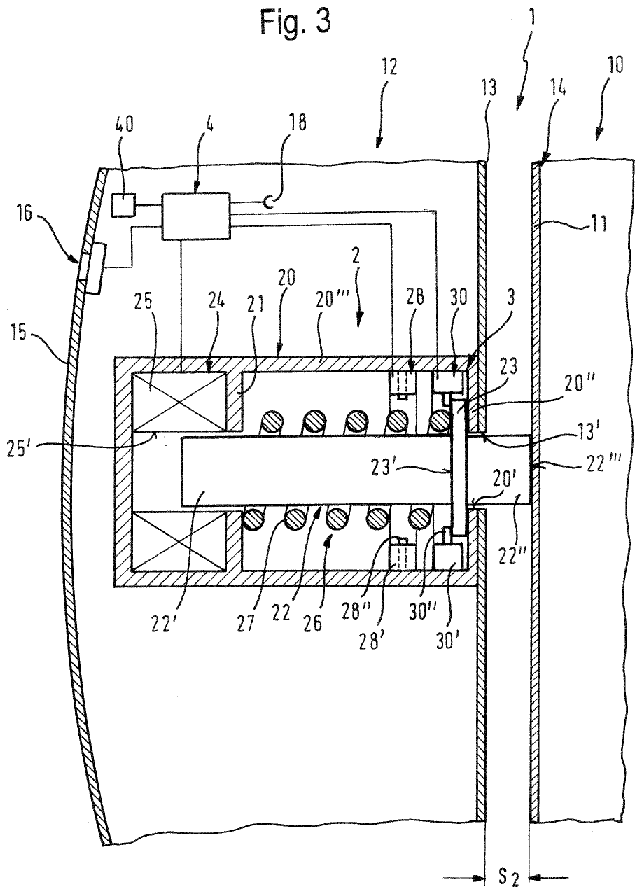

On the side of the circumferential collar 23 that faces away from the inner end face 22″, in the interior of the housing 20 which is fastened to the housing circumferential wall 20″, at least one restraining device 28 is provided, which is illustrated only schematically in the figures. The restraining device 28 has an annular restraining housing 28′ firmly connected to the housing 20 and at least one restraining arm 28″ movable radially inward out of the restraining housing 28′, toward the plunger 22. In FIGS. 1 to 3, two restraining arms 28″ are shown by way of example, but there can also be fewer or more. The respective restraining arm 28″ is movable, for example by an electric motor or electromagnetically, between the radially inwardly extended position illustrated in FIG. 1 and a position retracted radially outward into the restraining housing 28′ shown in FIG. 3.

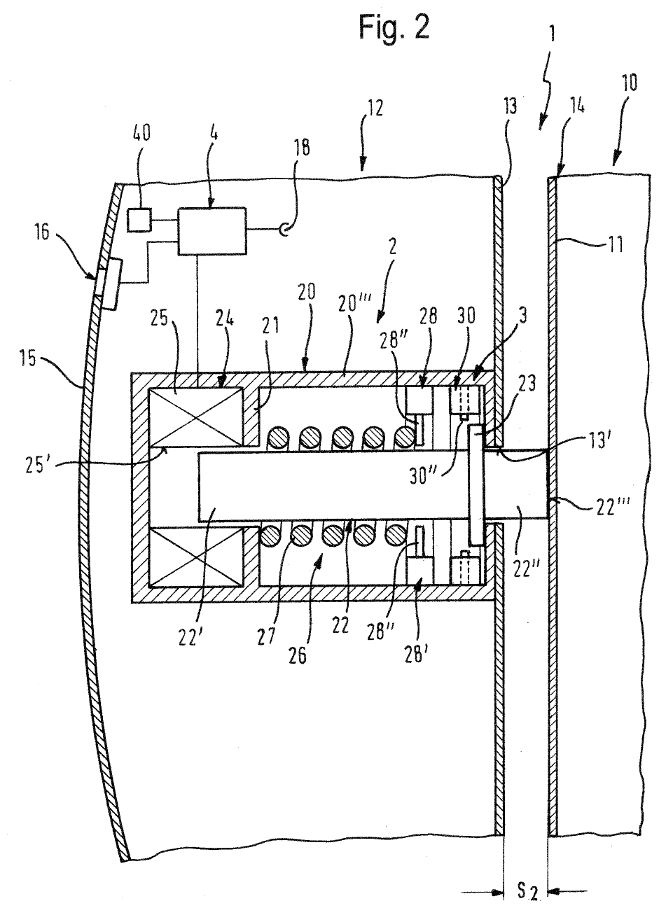

In the extended position of the restraining arm 28″ illustrated in FIG. 1 and FIG. 2, its radially inner free end 28″ is located in the immediate vicinity of the outer circumference of the plunger 22 but without touching the latter. In the resting position of the automatic door opener 2 shown in FIG. 1 and also in the actuation position illustrated in FIG. 2, in normal operation, between the respective restraining arm 28″ of the respective restraining device 28 there is arranged a compressed spring 27 formed as a compression spring, which is supported with its end on the body side against the restraining arms 28″ of the restraining device 28 and, with its end remote from the body, is supported against an annular housing inner wall 21 of the housing 20 through which the plunger 22 reaches. This housing inner wall 21 at the same time delimits the installation space for the electromagnetic drive device 25, which is located on the side of the annular housing inner wall 21 that faces away from the spring 27. The spring 27, formed as a compression spring, is therefore supported in its pretensioned state between the annular housing inner wall 21 and the retaining arms 28″ of the restraining device 28.

In the interior of the housing 20, between the restraining device 28 and the housing end wall 20″ that faces the door inner wall 13, there is provided a locking device 30, designed comparably with the restraining device 28, of a securing mechanism 3 which—in a manner analogous to the restraining device 28—has a circumferential annular locking device housing 30′ and at least one locking arm 30″ that can be retracted and extended in the radial direction out of the locking device housing 30′. In FIGS. 1 to 3, two locking arms 30″ are shown by way of example, but there can also be fewer or more. In the resting position illustrated in FIG. 1 and also in the actuation position in normal operation illustrated in FIG. 2, the locking arms 30″ are retracted radially outward into the annular locking device housing 30′ and, as a result, do not hinder the longitudinal mobility of the plunger 22.

With reference to FIG. 2, the normal operation of the automatic door opener 2 will be described below, it being assumed that an associated door lock has previously been unlocked or is unlocked at the same time to such an extent that a locking bolt can escape from a locking latch of the door lock.

If, in normal operation of the automatic door opener 2, an electric contactor 16 provided in the door outer skin 15, for example a pushbutton or a sensor or a contactor that can be activated without touch and is hidden behind the door outer skin 15, is actuated, then an actuating signal is transmitted to a control device 4, illustrated only schematically in the figures, whereupon electrical energy from a vehicle electrical system 18 of the vehicle 1 is applied to the electromagnetic drive unit 25 of the plunger drive 4. The plunger 22, forming an armature for the electromagnet of the electromagnetic drive device 25, is then moved to the right in FIG. 2, that is to say in the direction toward the doorframe wall 11. The second end 22″ of the plunger 22 emerges out of the opening 13′ of the door inner wall 13 and overcomes the gap S₁. so that the end face 22″ of the plunger 22 comes to bear on the doorframe wall 11. The plunger 22 is moved to the right until the circumferential collar 23 comes into contact with the inner side of the annular housing end wall 20″. The vehicle door 12 is forced away from the doorframe wall 11 of the doorframe 14 on the body side, the gap S₂ which is formed between the door inner wall 13 and the doorframe wall 11 being enlarged. The gap S₂ is thus larger than the gap S₁. The vehicle door 12, thus forced slightly out of the door opening, can then be gripped at the edge of the door outer skin 15 from outside, and, as a result, the vehicle door 12 can be pulled into its opening position from outside. As can be seen in FIG. 2, the spring 27 of the auxiliary drive 26 remains pretensioned in its position between the annular housing inner wall 21 and the restraining arms 28″ of the restraining device 28.

The emergency operation and the overload operation of the automatic door opener 2 will be described below with reference to FIG. 3, it also being assumed here that an associated door lock has previously been unlocked or is unlocked at the same time to such an extent that the lock bolt can escape from the door latch of the door lock.

In emergency operation, that is to say when no or no longer sufficient electrical energy is available in the vehicle electrical system 18 in order to actuate the electromagnetic drive device 25 of the plunger drive 24, because for example after an accident, the vehicle electrical system 18 of the motor vehicle 1 has been disconnected or, for example, the vehicle battery has been emptied, the automatic door opener 2 is activated via an emergency actuation of the auxiliary drive 26.

If the electric contactor 16 is actuated in the emergency operation, then an emergency power supply 40 that is active for a limited time period but at least for one hour, preferably for 24 hours, for example an accumulator or a supercapacitor, supplies the control device 4, the electric door lock and the restraining device 28 as well as the locking device 30 of the security mechanism 3 with electrical energy. In this case, in the event of an actuation of the electric contactor 16, the restraining device 28 receives a restraining actuator activation signal from the control device 4 and the restraining arms 28″ are thereupon pulled radially outward into the annular restraining device housing 28′ by an actuator device, not illustrated, of the restraining device 28. As a result, they release the compressed spring 27, which then expands, comes to bear on the circumferential collar 23 of the plunger 22 and moves the plunger 22 (to the right in FIGS. 1 to 3). The second end 22″ of the plunger 22—as in regular normal operation-protrudes from the opening 13′ of the door inner wall 13 and overcomes the gap S₁, so that the end face 22″ of the plunger 22 comes to bear on the doorframe wall 11 and forces the vehicle door 12 away from the doorframe wall 11 of the doorframe 14 on the body side, as is also the case in normal operation under the influence of the electric plunger drive. The vehicle door 12 forced slightly out of the door opening by the force of the spring 27, as also in emergency operation, enlarging the gap S₁ to gap S₂, can now be gripped from outside at the edge of the door outer skin 15 and, as a result, the vehicle door 12 can be pulled into its opening position from outside.

Otherwise than in normal operation, electrical energy can now additionally be applied to the locking device 30, wherein the locking device 30 receives a locking actuator activation signal from the control device 4, wherein the locking arms 30″ are moved radially inward out of the locking device housing 30′ by an actuator device, not illustrated, of the locking device 30 and engage behind the circumferential collar 23 of the plunger 22 on an annular end face 23′ of the circumferential collar 23 that faces away from the end face 22″ of the plunger 22 and, as a result, prevent the plunger 22 from moving back into the housing 20. The vehicle door 12 can therefore no longer fall back into the completely closed position illustrated in FIG. 1.

In the event of an overload, that is to say when the force of the electric plunger element 24 is not sufficient, in addition to the power supply of the electric plunger drive 24 from the electrical supply 18 and to the activation of the electrical plunger drive 24, the restraining device 26 is also supplied with electrical energy and activated as a result, in order also additionally to release the spring 27 of the mechanically designed auxiliary drive 26, which then, as in the emergency actuation, moves the plunger 22 together with the force applied by the electric plunger drive 24 in the direction of the doorframe wall 11 and forces it against the latter. However, in the event of an overload, the plunger 22 is not locked by the locking device 30. The plunger 22 remains freely axially movable and can be drawn back again by the electric plunger drive 24, the spring 27 being tensioned again and fixed in its tensioned position again by the restraining device 28.

Although, in the example described above, the automatic door opener 2 is provided in the vehicle door 12, it is equally well possible and also comprised by the invention to arrange the automatic door opener 2 to be fixed to the body and to allow the plunger 22 to press against the vehicle door 12.

The invention is not restricted to the mechanical energy store formed above by way of example by a compression spring, instead it is alternatively possible for a pneumatic or a hydraulic pressure reservoir to be provided for the separate auxiliary drive as an energy store, or the auxiliary drive can be drivable by means of a pyrotechnically produced pressurized gas.

The invention is not restricted to the above exemplary embodiment, which serves merely for the general explanation of the core idea of the invention. Within the framework of the protective scope, the device according to the invention can instead also assume other configuration forms than those described above. The device can in particular have features which represent a combination of the respective individual features of the claims.

Designations in the claims, the description and the drawings are used merely for the better understanding of the invention and are not intended to restrict the protective scope.

### List of Designations

1 Motor vehicle
2 Automatic door opener
3 Securing mechanism
4 Control device
10 Vehicle body
11 Doorframe wall
12 Vehicle door
13 Door inner wall
13 Opening in 13
14 Doorframe on the body side
15 Door outer skin
16 Electric contactor
18 Vehicle electrical system
20 Housing
20′ Housing opening
20″ Housing front wall
20″ Housing circumferential wall
21 Housing inner wall
22 Plunger
22′ First end
22″ Second end
22″ End face
23 Circumferential collar
23′ Annular end face of 23
24 Electric plunger drive
25 Electromagnetic drive device
25′ Central opening of 25
26 Separate auxiliary drive
27 Spring
28 Restraining device
28 Restraining device housing
28″ Restraining arm
30 Locking device
30′ Locking device housing
30″ Locking arm
40 Emergency power supply
S₁ Small air gap
S₂ Large air gap

1-10. (canceled)

11. An automatic door opener for use in a motor vehicle, comprising:
a housing;
a plunger mounted to be longitudinally movable in the housing;
an electric plunger drive configured to move the plunger forward and back between a resting position, in which the plunger is withdrawn into the housing, and an actuation position, in which the plunger protrudes out of the housing; and
an auxiliary drive having an energy store provided in addition to the electric plunger drive, which auxiliary drive is pretensioned into the actuation position,
wherein the auxiliary drive, which is provided separately from the electric plunger drive, is configured to be activated independently of the electric plunger drive and, when activated via energy stored in the energy store, is configured to be able to move the plunger from the resting position to the actuation position.

12. The automatic door opener according to claim 11, wherein
the electric plunger drive has an electrical or electromagnetic drive device.

13. The automatic door opener according to claim 11, wherein
the auxiliary drive has a spring or is formed by a spring, which spring acts between the housing and the plunger and which, in a standby position, assumes a state pretensioned in a direction of the actuation position of the plunger and is maintained in said pretensioned state by a restraining device.

14. The automatic door opener according to claim 13, wherein
the spring is a compression spring.

15. The automatic door opener according to claim 13, wherein
the restraining device is triggered electrically to release the spring.

16. The automatic door opener according to claim 13, wherein
the electric plunger drive is configured to move the plunger from the actuation position to the resting position counter to a force of the spring when the auxiliary drive is triggered, and to secure the spring in the pretensioned state via the restraining device.

17. The automatic door opener according to claim 11, further comprising:
a lock provided to lock the plunger moved into the actuation position by the triggered auxiliary drive in the actuation position.

18. A motor vehicle, comprising:
a vehicle body having a doorframe;
at least one vehicle door with an electrically operable door lock; and
at least one automatic door opener according to claim 11,
wherein the at least one automatic door opener is provided to exert a force between the at least one vehicle door and the doorframe of the body side or another component fixed to the body.

19. The motor vehicle according to claim 18, further comprising:
an electric control device configured to supply the electrically operable door lock and the electric plunger drive with electrical energy when an electric contactor is actuated,
wherein the electric control device is configured to unlock the electrically operable door lock in an event of an overload of the electric plunger drive or following receipt of a crash signal representing a vehicle accident when the electric contactor is actuated, and to trigger a restraining device electrically or electromechanically and as a result to activate the auxiliary drive.

20. The motor vehicle according to claim 19, further comprising:
an emergency power supply which, in an event of an accident-based disconnection of a vehicle electrical system of the motor vehicle or a failure of the vehicle electrical system in the motor vehicle, supplies at least the electric control device, the electrically operable door lock, and the restraining device with electrical energy.
